(19) United States
(12) Patent Application Publication
(10) Pub. No.: US 2007/0014574 A1
(43) Pub. Date: Jan. 18, 2007

(54) Optical communication system having optical amplification function

(76) Inventor: Katsuhiro Yada, Osaka (JP)

Correspondence Address: MCDERMOTT WILL & EMERY LLP, 600 13TH STREET, N.W., WASHINGTON, DC, 20005-3096, US

(21) Appl. No.: 10/551,474

(22) PCT Filed: Oct. 21, 2004
(86) PCT No.: PCT/JP04/04664

§ 371 Date: Sep. 30, 2005

(30) Foreign Application Priority Data
Apr. 2, 2003 (JP) 2003-099570
Apr. 15, 2003 (JP) 2003-110699

(51) Int. Cl. H04J 14/00

(52) U.S. Cl. 398/71

(57) ABSTRACT

In optical communications between a base station and a local station, the wavelength of a laser light source for a signal, high LD, in the base station that generates downstream signal light is set to a wavelength with an effect of Raman amplifying an upstream light signal that propagates through an optical fiber 2. In the optical fiber 2, an upstream light signal transmitted from the local station to the base station is amplified with the downstream signal light from the laser light source for a signal, high LD, while the upstream light signal is propagating through the optical fiber 2.

### FIELD OF THE INVENTION

The present invention relates to an optical communications system in which a base station and a local station are connected using an optical fiber.

The invention relates to an optical communications system, and more particularly, to a PON (Passive Optical Network) system in which a base station and an optical branching station equipped with a passive optical divider are connected using a backbone optical fiber, and the optical branching station and plural local stations are connected individually using branch optical fibers.

### BACKGROUND ART

In a system enabling two-way communications between a base station and plural local stations using an optical data communications network, a network configuration (Single Star) connecting the base station and the respective local stations in a radial pattern using a single optical fiber for each local station is now put into practical use. With this network configuration, the system and the device configuration can be simpler; however, because each local station occupies a single optical fiber, it is difficult to reduce the cost of the system.

Such being the case, a PON (Passive Optical Network) system (referred to also as PDS (Passive Double Star)), in which a single optical fiber is shared among plural local stations, has been proposed. In the PON system, the base station and the optical branching station equipped with a passive optical divider are connected using a backbone optical fiber, and the optical branching station and plural local stations are individually connected using branch optical fibers.

In the PON system, in order to ensure power needed for optical transmission, a configuration to amplify a light signal traveling through the optical fiber by incorporating an optical amplifier into the optical branching station has been proposed (see Japanese Unexamined Patent Publication No. 9-181686 (1997)A).

The configuration as above, however, has problems that the use of the optical amplifier in the optical branching station increases the cost for the purchase and installment, and that maintenance takes time and labor because a technical person has to go to the optical branching station in the event of trouble after installment.

Also, besides the PON system, an optical amplifier is inserted to the optical fibers between the base station and plural local stations in a normal optical communications system. However, there are problems that the use of the optical amplifier increases the cost for the purchase and installment, and that maintenance takes time and labor because a technical person has to go to the site where optical amplifier is installed in the event of trouble after installment.

Hence, if one succeeds in distributing and furnishing the amplification function to optical fibers instead of using an optical amplifier as a single item, the maintenance can be easier and-a reduction of the cost can be expected due to mass-production.

### DESCRIPTION OF THE INVENTION

The invention therefore has an object to provide an optical communications system capable of furnishing optical fibers with the optical amplification function.

An optical communications system of the invention is characterized in that a wavelength of a light source for a signal that generates downstream signal light is set to a wavelength with an effect of Raman amplifying an upstream light signal that propagates through an optical fiber, and an upstream light signal transmitted between a base station and a local station is amplified in the optical fiber while the upstream light signal is propagating through the optical fiber.

According to this configuration, light for a signal having a wavelength with an effect of amplifying an upstream light signal is generated using the light source for a signal, and the light for a signal is transmitted to the local station via the optical fiber. It is thus possible to amplify upstream signal light traveling through the optical fiber with ease. The base station and the local station can be chosen arbitrarily, and either station equipped with a light source for a signal having a wavelength with the Raman amplification effect can be used as the base station.

FIG. 15 is a graph showing the conditions of the Raman amplification, using the abscissa for a wavelength and the ordinate for optical power during propagation. Assume that signal light and light for amplification propagate in directions opposite to each other. In order to perform the Raman amplification, it is sufficient for the wavelength of light for amplification to be about 0.1 μm shorter than the wavelength of signal light.

Further, as the amplification conditions, it is preferable that the Raman gain, (gR/Aeff)PpLeff, is 0.1 dB or higher, where (gR/Aeff) is a Raman gain coefficient of the optical fiber, Pp is pumping power inputted into the optical fiber, and Leff is an effective distance along the optical fiber over which pumping light functions.

It is preferable that a high nonlinearity fiber is used for at least part of the optical fiber (Claim 2). The high nonlinearity fiber referred to herein is defined as an optical fiber having the Raman gain, (gR/Aeff)PpLeff, of 4 dB or higher. For example, it can be manufactured by slightly reducing the core diameter from that of a general single mode optical fiber. Because a high nonlinearity effect can be achieved with the use of the high nonlinearity fiber, the amplification gain of a light signal can be set high. It is thus possible to amplify an upstream signal even when the light source for a signal that generates downstream signal light has relatively low power or the distance is short. The term “at least part of” is used because the high nonlinearity fiber does not have to be used for the entire transmission path, and it is sufficient to use the high nonlinearity fiber for a distance long enough to obtain a needed amplification gain. For example, in the case of long distance transmission, it is effective to connect the high nonlinearity fiber and an SMF (Single Mode Fiber) in series while forming a portion closer to the light source for a signal in the base station using the high nonlinearity fiber and a remote portion using the SMF.

Light that is switched ON and OFF may be used as the downstream signal light, and a modulation method, by which an ON state and an OFF state transit even when coded data is a sequence of 0's and the ON state and the OFF state transit even when the coded data is a sequence of 1's, may be used as a modulation method for the downstream signal light (Claim 3). When configured in this manner, fluctuation of the amplification gain can be suppressed because the ON state does not continue for a long period and the OFF state does not continue for a long period, either, which enables a stable amplification characteristic to be achieved. In particular, this is effective in suppressing fluctuation of the amplification gain when a ratio of the ON state and the OFF state is constant.

It is preferable that, in the optical fiber, a length of a portion where upstream signal light is amplified is of a distance longer than a length of the optical fiber corresponding to a set of the ON state and the OFF state of the downstream signal light (Claim 4). For example, assume that a light signal propagates an optical fiber having a given length L (m) at a rate, c/n (m/sec), where c is a rate of light in vacuum and n is an effective refractive index of the optical fiber. Given A (bits/sec) as the transmission rate of a signal when an encoding method, by which a bits are transmitted by one set of an ON state and an OFF state on average, is used, then nLA/αc sets of an ON state and an OFF state are present in the optical fiber having the length L (m). Because a signal light is present in about half the sets of an ON state and an OFF state of downstream signal light, by making the length L (m) of the optical fiber longer than αc/nA (m), it is possible to perform the stable Raman amplification over the length L (m) of the optical fiber.

It is preferable that, in the base station, an optical filter used to select a wavelength of light coming incident on a light-receiving element is provided (Claim 5).

A PON system of the invention is characterized in that a wavelength of a light source for a signal that generates downstream signal light is set to a wavelength with an effect of Raman amplifying an upstream light signal that propagates through a backbone optical fiber, and an upstream light signal transmitted between a base station and a local station is amplified in the backbone optical fiber while the upstream light signal is propagating through the backbone optical fiber (Claim 6).

According to the configuration as above, light for a signal having a wavelength with an effect of amplifying an upstream light signal is generated using the light source for a signal, and the light for a signal is distributed to local stations via a backbone optical fiber and by way of an optical multiplexer/demultiplexer. It is thus possible to amplify upstream signal light traveling through the backbone optical fiber with ease.

Because the Raman amplification is used as the function of amplifying a light signal, it is possible to distribute and amplify upstream signal light traveling through the optical fiber by allowing propagation of light for a downstream signal. As has been described, by furnishing the optical amplification function to the optical fiber, the need to prepare the optical amplifier in an optical branching station can be eliminated. A PON system of a simple configuration can be thus achieved.

It is preferable that a high nonlinearity fiber is used for at least part of the backbone optical fiber (Claim 7). Because a high nonlinearity effect can be achieved with the use of the high nonlinearity fiber, a high gain can be obtained with relatively weak amplifying light. Optical power of the light source for a signal may be therefore relatively low. In the case of long distance transmission, it is more effective to connect the high nonlinearity fiber and an SMF (Single Mode Fiber) in series while forming a portion closer to the light source for a signal in the base station using the high nonlinearity fiber and a remote portion using the SMF.

In the case above, by using a modulation method, by which an ON state and an OFF state transit even when coded data is a sequence of 0's and the ON state and the OFF state transit even when coded data is a sequence of 1's, as a modulation method for switching ON/OFF the downstream signal light (Claim 8), the Raman amplification can be performed on a light signal in an ON state. This enables the stable amplification characteristic to be achieved. When a method for subjecting signal light to polarization modulation or phase modulation is used, stable amplification can be performed constantly without having to concern the coding method, because optical power hardly varies with time.

Also, in order to achieve a stable amplification characteristic, it is preferable that, in the backbone optical fiber, a length of a portion where upstream signal light is amplified is of a distance longer than a length of the backbone optical fiber corresponding to a set of the ON state and the OFF state of the downstream signal light (Claim 9).

A concrete configuration of the PON system of the invention will now be described. Figure numbers inside the parentheses indicate corresponding figure numbers used in the descriptions of embodiments below.

As the configuration of the PON system of the invention, by providing the light source for a signal and an optical multiplexer/demultiplexer in the base station, and by pumping light for a signal into the backbone optical fiber from the base station toward the optical branching station by way of the optical multiplexer/demultiplexer, it is possible to amplify an upstream light signal between the base station and the optical branching station (Claim 10). Because a light signal from the local station travels over a long propagation path, and a distance between the base station and the optical branching station is long in many cases, it is effective to amplify the light signal over this distance.

In this system configuration, a star coupler can be used as a passive optical divider (Claim 11, FIG. 4). According to this configuration, the manufacturing and management costs can be saved by using an inexpensive star coupler. Also, because all the local stations can handle a light signal of the same wavelength, the manufacturing costs of the local stations can be reduced.

Also, in this system configuration, as the passive optical divider, a star coupler can be used for the downstream signal light, and an AWG capable of multiplexing and demultiplexing upstream signal light using a difference in wavelength can be used for the upstream signal light (Claim 12, FIG. 5). By using the AWG for an upstream signal, the upstream signal light can be multiplexed and demultiplexed at a small loss. This provides allowance to the optical power design regarding a light source for a signal in the local station.

Also, a PON system of the invention includes: a light source for amplification that generates light for amplification having a wavelength with an effect of amplifying a light signal propagating through an optical fiber (including a backbone optical fiber and a branch optical fiber); and an optical multiplexer/demultiplexer used to pump the light for amplification into the optical fiber. In the optical fiber, a light signal transmitted between a base station and a local station is amplified while the light signal is propagating through the optical fiber (Claim 13).

According to the configuration above, light for amplification having a wavelength with an effect of amplifying a light signal is generated using the light source for amplification, and the light for amplification is pumped into the optical fiber by way of the optical multiplexer/demultiplexer. It is thus possible to amplify the signal light traveling through the optical fiber with ease.

When the Raman amplification is used as a function of amplifying a light signal, by allowing the light for amplification to propagate in a direction opposite to the signal light (Claim 14), it is possible to distribute and amplify the signal light traveling through the optical fiber.

As an optical fiber achieving the Raman amplification, a high nonlinearity fiber can be used (Claim 15). Because a high nonlinearity effect can be achieved with the use of the high nonlinearity fiber, a high gain can be obtained with relatively weak amplifying light. In the case of long distance transmission, it is more effective to connect the high nonlinearity fiber and an SMF (Single Mode Fiber) while forming a portion closer to the light source for amplification using the high nonlinearity fiber and a remote portion using the SMF.

Besides the Raman amplification, when an erbium-doped fiber (EDF) is used as a function of amplifying the light signal (Claim 16), it is possible to amplify signal light in the same direction as the signal for amplification through the use of induced emission of erbium ions.

In the cases above, by using non-modulated light as the light for amplification, a further stable amplification characteristic can be achieved.

By providing the light source for amplification and the optical multiplexer/demultiplexer in the base station, and by pumping the light for amplification into the backbone optical fiber from the base station toward the optical branching station, it is possible to amplify a light signal between the base station and the optical branching station (Claim 17, FIG. 6). Because a light signal from the local station travels over a long propagation path, and a distance between the base station and the optical branching station is long in many cases, it is effective to amplify the light signal over this distance.

By providing the light source for amplification and the optical multiplexer/demultiplexer in the optical branching station, and by pumping the light for amplification into the backbone optical fiber from the optical multiplexer/demultiplexer toward the base station, it is possible to amplify a light signal between the base station and the optical branching station (Claim 18, FIG. 7).

In addition to the configuration set forth in claim 17, by providing a second optical multiplexer/demultiplexer, a third optical multiplexer/demultiplexer, and an optical path connecting the second optical multiplexer/demultiplexer and the third optical multiplexer/demultiplexer in the optical branching station, and by extracting the light for amplification that travels through a backbone optical fiber for an upstream signal from the second optical multiplexer/demultiplexer to be supplied to the third optical multiplexer/demultiplexer via the optical path, it is possible to pump the light for amplification into a backbone optical fiber for a downstream signal from the third optical multiplexer/demultiplexer toward the base station (Claim 19, FIG. 8).

According to this configuration, by pumping light for amplification traveling through the backbone optical fiber for an upstream signal from the base station again into the backbone optical fiber for a downstream signal toward the base station, it is possible to amplify downstream signal light. By setting the wavelengths of both the upstream signal light and the downstream signal light to the same wavelength, both the upstream and downstream signals can be amplified efficiently by a single light source for amplification.

A configuration, in which the light source for amplification and the optical multiplexer/demultiplexer are provided in the optical branching station, so that the light for amplification is pumped into the branch optical fiber by way of the passive optical divider toward the local station, may be adopted (Claim 20, FIG. 9). When configured in this manner, a light signal between the optical branching station and the local station can be also amplified.

Also, by providing the light source for amplification and the optical multiplexer/demultiplexer in the base station, and by pumping the light for amplification into the backbone optical fiber from the base station toward the optical branching station, while providing a reflector that allows the light for amplification to undergo total reflection to the backbone optical fiber in the optical branching station (Claim 21, FIG. 10), it is possible to amplify a light signal using the light source for amplification provided in the base station without having to provide the light source for amplification in the optical branching station. The reflector can be achieved, for example, by an FBG (Fiber Bragg Grating).

A configuration, in which the light source for amplification and the optical multiplexer/demultiplexer are provided in the base station for the light for amplification to be pumped into the backbone optical fiber from the base station toward the optical branching station, while a second optical multiplexer/demultiplexer and a reflector are provided in the optical branching station for the light for amplification that travels through the backbone optical fiber to be extracted from the second optical multiplexer/demultiplexer, so that the light for amplification is allowed to undergo total reflection on the reflector (Claim 22, FIG. 11), may be adopted. It is thus possible to amplify a light signal using the light source for amplification provided in the base station without having to provide the light source for amplification in the optical branching station.

A configuration, in which the optical multiplexer/demultiplexer is provided in the optical branching station and an optical fiber is provided between the base station and the optical branching station besides the backbone optical fiber, while the light source for amplification is provided in the base station for the light for amplification to be supplied to the optical multiplexer/demultiplexer via the optical fiber, so that the light for amplification is pumped into the backbone optical fiber from the optical multiplexer/demultiplexer toward the base station (Claim 23, FIG. 12), is also possible. According to this configuration, the need to provide the light source for amplification in the optical branching station can be eliminated by providing the optical fiber between the base station and the optical branching station. It is thus possible to maintain and manage the light source for amplification with ease. Also, operations of the optical multiplexer/demultiplexer can be obtained from the passive optical divider.

In the system configurations set forth in claim 17 through claim 23, a star coupler can be used as the passive optical divider (Claim 24). The manufacturing and the management costs can be saved by using an inexpensive star coupler.

A configuration, in which an optical fiber is provided between the base station and the optical branching station besides the backbone optical fiber, and the light source for amplification is provided in the base station, so that the light for amplification is pumped into one optical path of the optical multiplexer/demultiplexer on the local station side via the optical fiber toward the base station (Claim 25, FIG. 13), is also possible.

According to this configuration, the need to provide the light source for amplification in the optical branching station can be eliminated by providing the optical fiber between the base station and the optical branching station. It is thus possible to maintain and manage the light source for amplification with ease. Also, operations of the optical multiplexer/demultiplexer can be obtained from the passive optical divider. Hence, there is no need to prepare an optical multiplexer/demultiplexer other than the passive optical divider, which makes the configuration of the optical branching station simpler.

In the system configurations set forth in claim 17 through claim 25 (excluding claim 24), an AWG capable of multiplexing and demultiplexing light having different wavelengths can be used in the optical branching station (Claim 26). By using the AWG, amplifying light can be separated at a small loss.

As has been described, according to the invention, the need to prepare the optical amplifier in the optical branching station can be eliminated by furnishing the optical fiber with the optical amplification function. A PON system of a simple configuration can be thus achieved.

### BRIEF DESCRIPTION OF THE DRAWINGS

FIG. 1 is a block diagram showing an optical communications system furnished with an optical amplification function of the invention;

FIG. 2 is a network configuration view showing a state where an optical line terminal OLT in a base station 1 and an optical network unit ONU in a local station 5 are connected to each other;

FIG. 3 is a block diagram showing an overall PON system furnished with an optical amplification function of the invention;

FIG. 4 is a view showing the configuration of a PON system of the invention that amplifies an upstream signal propagating through a backbone optical fiber using a High LD for a signal in the base station;

FIG. 5 is a view showing the configuration of a PON system of the invention using a star coupler for downstream signal light and an AWG for upstream signal light to multiplex/demultiplex signal light;

FIG. 6 is a view showing the configuration of a PON system of the invention that amplifies an upstream signal propagating through backbone and branch optical fibers by providing an LD for amplification in the base station;

FIG. 7 is a view showing the configuration of a PON system of the invention that amplifies a downstream signal from the base station by providing an LD for amplification also in the optical branching station;

FIG. 8 is a view showing the configuration of a PON system of the invention capable of amplifying an upstream signal to the base station and a downstream signal from the base station by merely providing one LD for amplification in the base station;

FIG. 9 is a view showing the configuration of a PON system, including an additional configuration to the configuration of FIG. 7, that amplifies an upstream light signal from the local station to the base station with light from an LDb for amplification provided in the optical branching station;

FIG. 10 is a view showing the configuration of a PON system of the invention in which LD 2 and LD 3 for amplification are provided in the base station, so that a downstream signal propagating through a backbone optical fiber can be amplified with light from the LD 2, and an upstream signal propagating through the backbone and the branch optical fibers can be amplified with light from the LD 3;

FIG. 11 is a view showing the configuration of a PON system of the invention in which LD 2 and LD 3 for amplification are provided in the base station, so that a downstream signal propagating through a backbone optical fiber can be amplified with light from the LD 2, and an upstream signal propagating through the backbone and branch optical fibers can be amplified with light from the LD 3;

FIG. 12 is a view showing the configuration of a PON system of the invention in which LD 1 and LD 2 for amplification are provided in the base station, so that upstream and downstream signals propagating through a backbone optical fiber can be amplified;

FIG. 13 is a view showing the configuration of a PON system of the invention in which two LD 1 and LD 2 for amplification are provided in the base station, so that upstream and downstream signals propagating through a backbone optical fiber can be amplified;

FIG. 14 is a perspective view showing the structure of a WDMF; and

FIG. 15 is a graph showing the conditions of the Raman amplification regarding a wavelength with respect to optical power.

### BEST MODE FOR CARRYING OUT THE INVENTION

Hereinafter, embodiments of the invention will be described in detail with reference to the accompanying drawings.

A. Optical Communications System

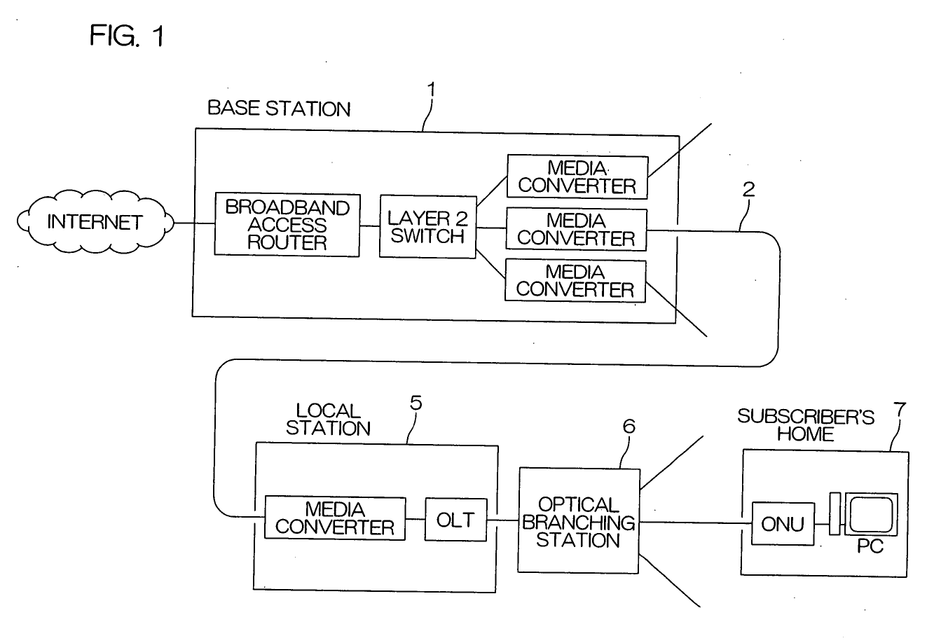

FIG. 1 is a block diagram showing an optical communications system furnished with an optical amplification function of the invention. A portion forming the optical communications system in the station building is referred to as the base station, and a portion forming the optical communications system in a relay station is referred to as the local station. The optical communications system includes a base station 1, a local station 5, an optical branching station 6, and a subscriber's home 7. The base station 1 and the local station 5 are connected using an optical fiber 2. The optical fiber 2 uses a single mode fiber.

Each of a down transmission signal from the base station 1 to the local station 5 and an up transmission signal from the local station 5 to the base station 1 comprises packets.

The base station 1 is furnished with a function of receiving packets sent from an upper network (Internet or the like) and sending these packets to the local station 5 via the optical network, and a function of receiving packets sent from the local station 5 and sending these packets to the upper network.

The base station 1 includes a media converter serving as a connection end to the optical fiber, a layer 2 switch, a broadband access router serving as a connection end to the upper network, etc.

The local station 5 includes a media converter to transmit/receive a broadband signal to/from the optical network, an optical line terminal OLT, etc.

The subscriber's home 7 includes a personal computer PC installed within the house, an optical network unit ONU that transmits/receives a broadband signal outgoing from/incoming to the personal computer PC to/from the optical network, etc.

To briefly describe operations of the optical communications system, down packets coming into the base station 1 from the upper network are subjected to specific processing in the layer 2 switch of the base station 1. These packets are transmitted to the optical network by way of the media converter. A light signal transmitted to the optical network is transmitted to the local station 5, and the local station 5 takes in the light signal to decode the packets.

Meanwhile, up packets transmitted from the local station 5 are transmitted to the base station 1. In the base station 1, after the specific processing in the layer 2 switch, the packets are transmitted therefrom to the upper network via the broadband access router.

An encoding method of a signal transmitted from the base station 1 adopts a method by which the signal is biased to neither the high level nor the low level even when data remains in a 0- or 1-state for a long period. For example, the Manchester encoding method can be adopted, according to which when data indicates 0, the signal is inverted from the high level to the low level at the center of the bit, and when data indicates 1, the signal is inverted from the low level to the high level at the center of the bit. When the NRZ encoding method is adopted, the same advantages can be obtained by using a scheme such as converting data by adding redundancy bits to the original data to avoid a sequence of 1's or 0's.

The optical amplification function furnished to the optical network will now be described.

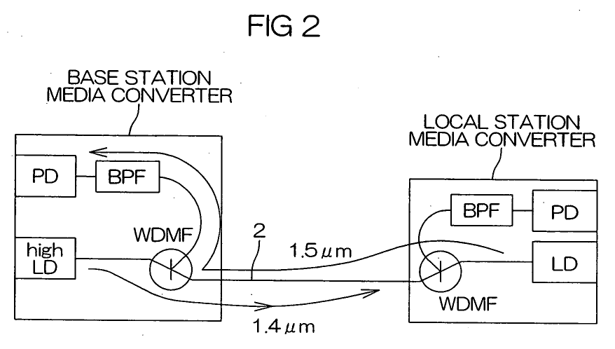

FIG. 2 is a network configuration view showing a state where the media converter in the base station 1 and the media converter in the local station 5 are connected to each other. According to this configuration, a high-power laser diode for a signal (High LD) is provided to the media converter in the base station 1, and an upstream signal from the local station 5 to the base station 1 is amplified with light from this laser diode.

The media converter in the base station 1 includes a laser diode for a downstream signal (High LD, transmission wavelength: 1.4 μm) and a photo diode for an upstream signal (PD, reception wavelength: 1.5 μm). Both the High LD and the PD are connected to the optical fiber 2 by way of a WDMF (Wavelength Division Multiplexing Filter). A bandpass optical filter BPF that allows passing of a desired reception wavelength alone is added to the PD.

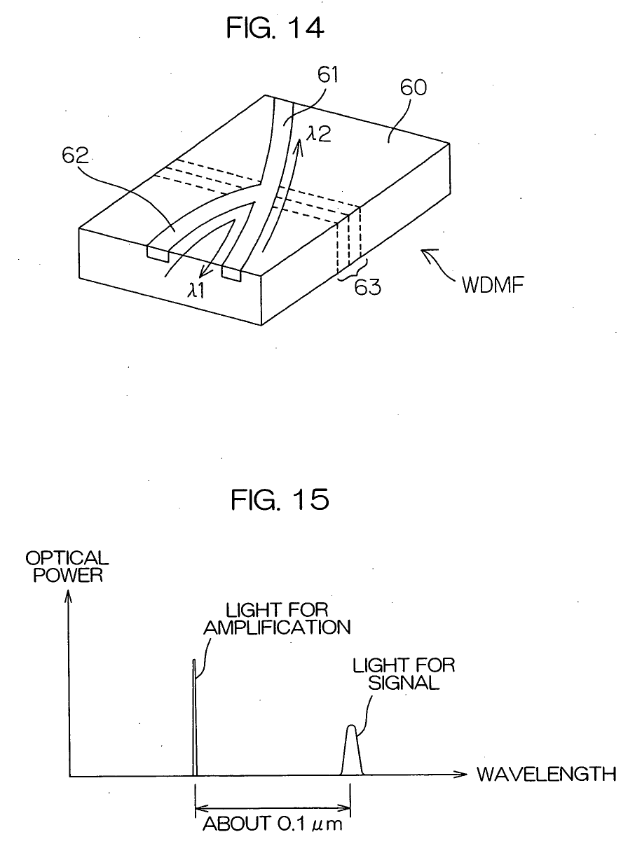

As is shown in FIG. 14, the WDMF has a structure in which λ-shaped waveguides 61 and 62 are provided to a dielectric substrate 60, and a dielectric multi-layer film filter 63 is provided at the contact point of the waveguides 61 and 62. Light having a wavelength λ1 propagates through the waveguide 62 and is reflected at the contact point, whereas light having a wavelength λ2 propagates through the waveguide 61 and passes through the contact point. A range of the wavelength λ1 to be reflected and a range of the wavelength λ2 to be allowed to pass can be set with the design of the dielectric multi-layer film filter 63.

The media converter in the local station 5 includes a laser diode for an upstream signal (LD for a signal, transmission wavelength: 1.5 μm), a photo diode for a downstream signal (PD, reception wavelength: 1.4 μm), a WDMF, and a BPF.

Light having a wavelength of 1.4 μm from the High LD in the base station 1 passes through the WDMF, and is received at the PD in the local station 5 via the optical fiber 2 by passing through the WDMF and the BPF of the media converter.

Light from the LD for a signal in the local station 5 passes through the WDMF, and goes into the media converter in the base station 1 via the optical fiber 2. Light for this upstream signal is reflected on the WDMF in the base station 1, and received at the PD in the base station 1.

Because the light having a wavelength of 1.4 μm from the High LD in the base station 1 has a wavelength about 0.1 μm shorter than light for an upstream signal having a wavelength of 1.5 μm, it is possible to amplify light for an upstream signal having a wavelength of 1.5 μm in the optical fiber 2.

It should be noted that by forming part of, for example, a 3-km-long portion of the optical fiber 2 on the base station side using a high nonlinearity fiber (HNLF) and forming the remaining portion using an SMF (Single Mode Fiber), upstream signal light can be amplified more effectively.

The configuration in FIG. 2 shows an example of power design. Given that the optical fiber 2 is 100-km long, then a 4-km-long portion closer to the media converter in the base station is formed using an HNLF, and the remaining 96-km-long portion closer to the optical branching station is formed using an SMF.

Assume that a propagation loss in the HNLF is 0.7 dB/km at a wavelength of 1.4 μm and 0.5 dB/km at a wavelength of 1.5 μm. Assume that a propagation loss in the SMF is 0.4 dB/km at a wavelength of 1.4 μm and 0.2 dB/km at a wavelength of 1.5 μm.

(Downstream Signal)

Optical power of High LD: 26 dBm

Transmission loss in WDMF: 1 dB

Propagation loss in HNLF: 0.7 dB/km×4 km=2.8 dB

Propagation loss in SMF: 0.4 dB/km×96 km=38.4 dB

Transmission loss in WDMF: 1 dB

Transmission loss in BPF: 1 dB

In the case specified as above, reception optical power at the media converter in the local station is −18.2 dBm.

(Upstream Signal)

Optical power of LD for signal: 0 dBm

Transmission loss in WDMF: 1 dB

Propagation loss in SMF: 0.2 dB/km×96 km=19.2 dB

Propagation loss in HNLF: 0.5 dB/km×4 km=2.0 dB

Raman gain in SMF: 1.2 dB→half, 0.6 dB

Raman gain in HNLF: 11.6 dB→half, 8.8 dB

Transmission/reflection loss in WDMF: 1 dB

Transmission loss in BPF: 1 dB

When the Raman gain in the optical fiber 2 is ignored, reception power of an upstream signal received at the PD in the base station is −24.2 dBm.

Because 25 dBm of down optical power is pumped into the optical fiber 2, mathematically, the Raman gain in the high nonlinearity portion of the optical fiber 2 is 11.6 dB, and the Raman gain in the SMF portion is 1.2 dB. However, the High LD of the media converter in the base station does not constantly emit light. Although a 1000BASE-LX light signal adopts the NRZ encoding, because redundancy 2 bits are appended to the original 8-bit data to convert the data so as to avoid a sequence of 0's or 1's, encoding takes place in such a manner that the number of 0-bits and the number of 1-bits are almost equal even in a silent state. The light-emitting time can be therefore deemed as nearly half. Then, the Raman gain in the HNLF of the optical fiber 2 is about half, 8.8 dB, and the Raman gain in the SMF is about half, 0.6 dB. Hence, the reception power at the PD of the media converter in the base station is −14.8 dBm, which is a sum of −24.2 dBm and (8.8+0.6) dB. This is a level that the media converter in the base station can receive with allowance.

B. PON System

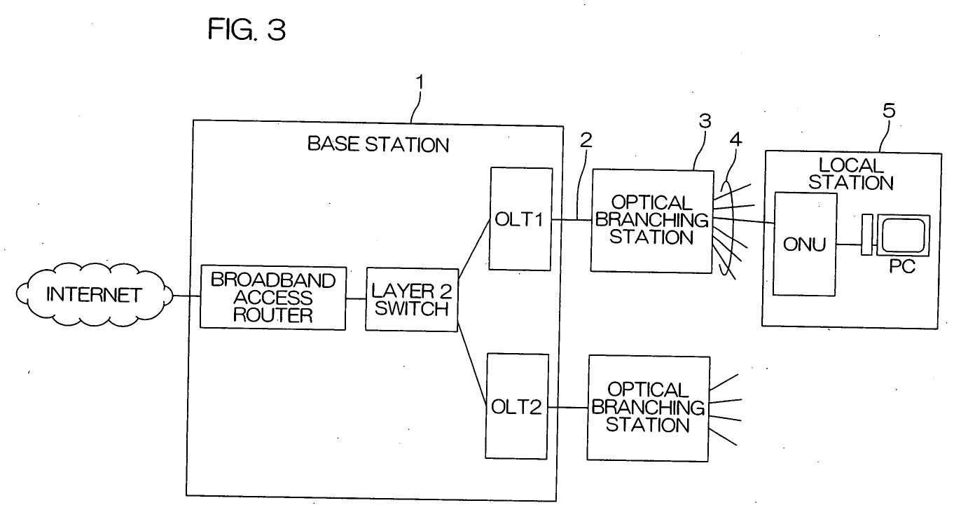

FIG. 3 is a block diagram showing a PON system with the optical amplification function of the invention. A portion forming the PON system in the station building is referred to as the base station, and a portion forming the PON system in the subscriber's home is referred to as the local station. The PON system includes a base station 1, plural local stations 5, and optical branching stations (referred to also as the remote nodes) 3. The base station 1 and each optical branching station 3 are connected using a single backbone optical fiber 2, and each optical branching station 3 and plural local stations 5 are connected individually using branch optical fibers 4. The backbone optical fiber 2 and the branch optical fibers 4 are collectively referred to as the optical fiber. The optical fiber uses a single mode fiber.

Each of a down transmission signal from the base station 1 to the local station 5 and an up transmission signal from the local station 5 to the base station 1 comprises packets.

The base station 1 is furnished with a function of receiving packets sent from an upper network (Internet or the like) and sending these packets to the local station 5 via the optical network, and a function of receiving packets sent from the local station 5 and sending these packets to the upper network.

The base station 1 includes an optical line terminal OLT serving as a connection end to the optical fiber, a layer 2 switch, a broadband access router serving as a connection end to the upper network, etc.

The local station 5 includes a personal computer PC installed within the house, an optical network unit ONU that transmits/receives a broadband signal outgoing from/incoming to the personal computer PC to/from the optical network, etc.

To briefly describe operations of the PON system, down packets coming into the base station 1 from the upper network are subjected to specific processing in the layer 2 switch of the base station 1. These packets are transmitted to the optical network by way of the optical line terminal (OLT) A light signal transmitted to the optical network is branched in the optical branching station 3, and transmitted to part or all of the local stations 5 connected to the optical branching station 3. A local station 5 whose address coincides with the address of the transmission destination takes in the light signal and decodes the packets.

Meanwhile, up packets transmitted from the local station 5 are transmitted to the base station 1 by way of the optical branching station 3. In the base station 1, after the specific processing in the layer 2 switch, the packets are transmitted therefrom to the upper network via the broadband access router.

An encoding method of a signal transmitted from the base station 1 adopts a method by which the signal is biased to neither the high level nor the low level even when data remains in a 0- or 1-state for a long period. For example, the Manchester encoding method can be adopted, according to which when data indicates 0, the signal is inverted from the high level to the low level at the center of the bit, and when data indicates 1, the signal is inverted from the low level to the high level at the center of the bit. When the NRZ encoding method is adopted, the same advantages can be obtained by using a scheme such as converting data by adding redundancy bits to the original data to avoid a sequence of 1's or 0's.

The configuration to achieve the optical amplification function furnished to the optical network will now be described.

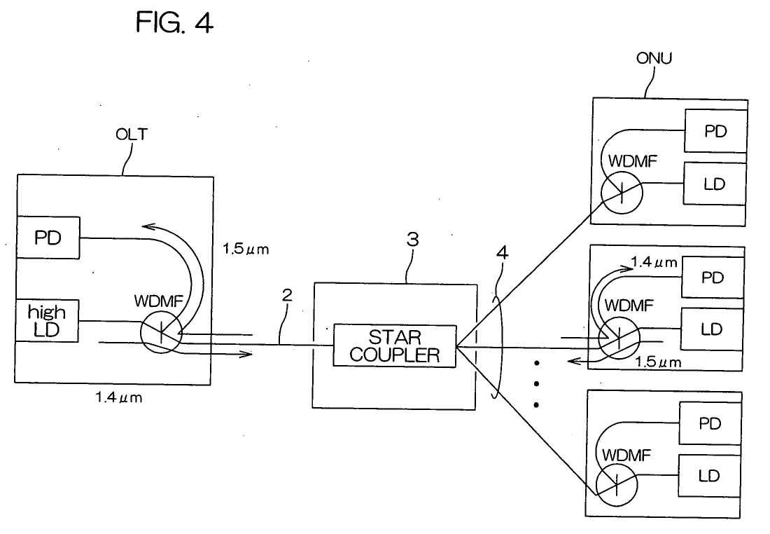

FIG. 4 is a network configuration view showing a state where the optical line terminal OLT in the base station 1, the optical branching station 3, and the optical network unit ONU in the local station 5 are interconnected. According to this configuration, an upstream signal from the optical branching station 3 to the base station 1 is amplified by providing a high-power laser diode for a signal (High LD) in the OLT.

The optical line terminal OLT includes a laser diode for a downstream signal (High LD, transmission wavelength: 1.4 μm) and a photo diode for an upstream signal (PD, reception wavelength: 1.5 μm). Both the High LD and the PD are connected to a backbone optical fiber 2 by way of a WDMF (Wavelength Division Multiplexing Filter).

As is shown in FIG. 14, the WDMF has a structure in which λ-shaped waveguides 61 and 62 are provided to a dielectric substrate 60, and a dielectric multi-layer film filter 63 is provided at the contact point of the waveguides 61 and 62. Light having a wavelength λ1 propagates through the waveguide 62 and is reflected at the contact point, whereas light having a wavelength λ2 propagates through the waveguide 61 and passes through the contact point. A range of the wavelength λ1 to be reflected and a range of the wavelength λ2 to be allowed to pass can be set with the design of the dielectric multi-layer film filter 63.

The optical network unit ONU in the local station 5 includes a laser diode for an upstream signal (LD for a signal, transmission wavelength: 1.5 μm) and a photo diode for a downstream signal (PD, reception wavelength: 1.4 μm).

The optical branching station 3 includes a star coupler, coupling the backbone optical fiber 2 to the branch optical fibers 4, for optical multiplexing and demultiplexing.

Light having a wavelength of 1.4 μm from the High LD in the base station 1 passes through the WDMF, and goes into the optical branching station 3 via the backbone optical fiber 2, in which the light is demultiplexed to plural (for example, 32) wavelengths by means of the star coupler. The beams of demultiplexed light propagate through the respective branch fibers 4, and are received at PD's of the optical network units ONU's in the respective local stations 5.

Light from the LD for a signal in the local station 5 travels through the branch optical fiber 4 and goes incident on the optical branching station 3, in which light is multiplexed by means of the star coupler. The multiplexed light goes into the optical line terminal OLT in the base station 1 via the backbone optical fiber 2. Light for this upstream signal is reflected on the WDMF in the OLT, and received at the PD in the base station 1.

Because the light having a wavelength of 1.4 μm from the High LD in the base station 1 has a wavelength about 0.1 μm shorter than light for an upstream signal having a wavelength of 1.5 μm, it is possible to amplify light for an upstream signal having a wavelength of 1.5 μm in the backbone optical fiber 2.

It should be noted that by forming, for example, a 3-km-long portion of the backbone optical fiber 2 on the base station side using a high nonlinearity fiber and forming the remaining portion using an SMF (Single Mode Fiber), upstream signal light can be amplified more effectively.

When the Raman amplification is used, light for a signal with high power is necessary, and safety has to be concerned. In this configuration, however, because amplifying light is attenuated by the transmission path and the star coupler, power of light for a signal in the subscriber's home and the ONU, in and with which a physical contact by the general subscriber is highly likely, is attenuated satisfactorily. The safety concerns are therefore unnecessary, or simple concerns are sufficient.

The configuration in FIG. 4 shows an example of power design. Given that the backbone optical fiber 2 is 12 km long, then a 3-km-long portion closer to the OLT is formed using a high nonlinearity fiber, and the remaining 9-km-long portion closer to the optical branching station is formed using an SMF. The branch optical fiber 4 is 4 km long.

(Downstream Signal)

Optical power of High LD in OLT: 24 dBm

Transmission loss in WDMF: 1 dB

Propagation loss in high nonlinearity backbone optical fiber 2:
0.7 dB/km×3 km=2.1 dB

Propagation loss in SMF backbone optical fiber 2:
0.4 dB/km×9 km=3.6 dB

Multiplexing/demultiplexing loss in star coupler:
18.5 dB

Propagation loss in branch optical fiber 4:
0.4 dB/km×4 km=1.6 dB

Transmission loss in WDMF: 1 dB

(Upstream Signal)

Optical power of LD for signal in ONU: 0 dBm

Transmission loss in WDMF: 1 dB

Propagation loss in branch optical fiber 4:
0.2 dB/km×4 km=0.8 dB

Multiplexing/demultiplexing loss in star coupler:
18.5 dB

Propagation loss in SMF backbone optical fiber 2:
0.2 dB/km×9 km=1.8 dB

Raman gain in SMF backbone optical fiber 2:
0.75 dB→half, 0.4 dB

Propagation loss in high nonlinearity backbone optical fiber 2:
0.5 dB/km×3 km=1.5 dB

Raman gain in high nonlinearity backbone optical fiber 2:
6.8 dB→half, 4.6 dB

Transmission/reflection loss in WDMF: 1 dB

In the case specified as above, at a point at which upstream signal light from the ONU passes through the star coupler by propagating through the branch optical fiber 4, signal power is −20.3 dBm.

When the Raman gain in the backbone optical fiber 2 is ignored, reception power of an upstream signal received at the PD in the base station is −24.6 dBm.

Because −23 dBm of down optical power is pumped into the backbone optical fiber 2, mathematically, the Raman gain in the high nonlinearity portion of the backbone optical fiber 2 is 6.8 dB, and the Raman gain in the SMF portion is 0.75 dB. However, the High LD in the OLT does not constantly emit light. Although a 1000BASE-LX light signal adopts the NRZ encoding, because redundancy 2 bits are appended to the original 8-bit data to convert the data so as to avoid a sequence of 0's or 1's, encoding takes place in such a manner that the number of 0-bits and the number of 1-bits are almost equal even in a silent state. The light-emitting time can be therefore deemed as nearly half. Then, the Raman gain in the high nonlinearity portion of the backbone optical fiber 2 is about half, 4.6 dB, and the Raman gain in the SMF portion is about half, 0.4 dB. Hence, the reception power at the PD in the OLT in the base station is −19.6 dBm as a result of the addition of (4.6+0.4) dB, which is the gain in the backbone optical fiber 2. This is a level that the OLT can receive with allowance.

The reception power at the ONU when light from the High LD in the OLT reaches the ONU is −3.8 dBm. This is power at a safe level when the subscriber has a physical contact.

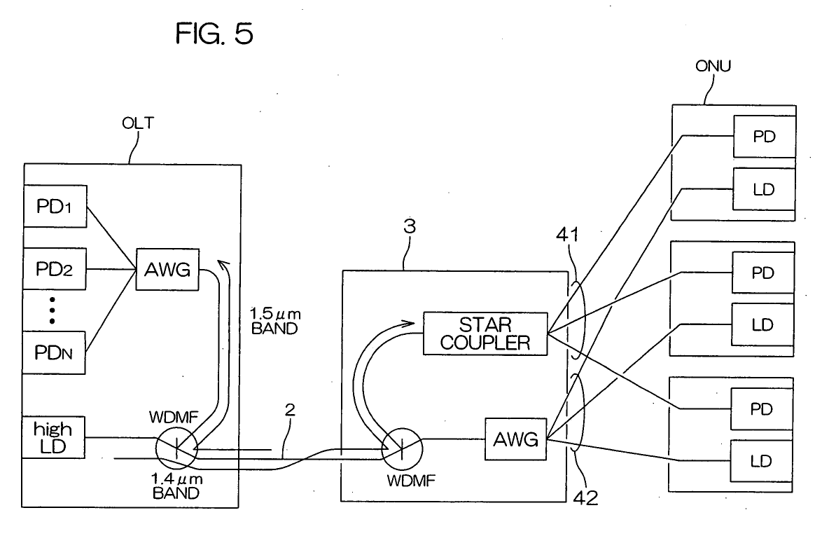

FIG. 5 is a network configuration view showing a state where the optical line terminal OLT in the base station 1, the optical branching station 3, and the optical network unit ONU in the local station 5 are interconnected. According to this configuration, a high-power laser diode for a signal (High LD, transmission wavelength: 1.4 μm), and plural photo diodes for an upstream signal(PD 1 through PD N, reception wavelength: 1.5 μm band) are provided in the OLT. Further, an AWG that subjects upstream signal light coming into the OLT to wavelength division is provided. Both the AWG and the High LD are connected to a backbone optical fiber 2 by way of a WDMF.

The optical branching station 3 is provided with the WDMF and the AWG. The WDMF reflects light having a wavelength of 1.4 μm from the High LD to be supplied to the star coupler. The star coupler sends downstream signal light to the respective ONU's via the branch optical fibers 41. The AWG multiplexes upstream signals propagating through the branch optical fibers 42 and sends the multiplexed signal to the backbone optical fiber 2.

Light having a wavelength of 1.4 μm from the High LD in the base station 1 passes through the WDMF, and goes into the optical branching station 3 via the backbone optical fiber 2. The light is then reflected on the WDMF and demultiplexed to plural (for example, 32) wavelengths by means of the star coupler. The beams of demultiplexed light then travel through the respective branch optical fibers 41, and are received at the PD's in the optical network unit ONU's in the respective local stations 5.

Light having a wavelength of 1.5 μm band from the LD for a signal in the ONU in the local station 5 goes incident on the optical branching station 3 via the branch optical fiber 42. The light is then subjected to wavelength division multiplexing (WDM) in the AWG, after which it passes through the WDMF, and goes into the OLT in the base station 1 by propagating through the backbone optical fiber 2. Light of this upstream signal is reflected on the WDMF in the OLT, and is further demultiplexed in the AWG according to wavelengths to be received at any of the PD 1 through PD N in the base station 1.

Because light having a wavelength of 1.4 μm from the High LD in the base station 1 has a wavelength about 0.1 μm shorter than light for an upstream signal having a wavelength of 1.5 μm band, it is possible to amplify light for an upstream signal having a wavelength of 1.5 μm band in the backbone optical fiber 2.

Further, because this configuration uses the AWG having a small loss when multiplexing and demultiplexing upstream light signals, power of the LD for a signal in the ONU can be lowered. This makes it easy to ensure the safety in the subscriber's home and the ONU, in and with which a physical contact by the subscriber is highly likely.

The configuration in FIG. 5 shows an example of power design. Given that the backbone optical fiber 2 is 20 km long, then a 3-km-long portion closer to the OLT is formed using a high nonlinearity fiber, and the remaining 17-km-long portion closer to the optical branching station is formed using an SMF. The branch optical fibers 41 and 42 are 4 km long.

(Downstream Signal)

Optical power of High LD in OLT: 24 dBm

Transmission loss in WDMF: 1 dB

Propagation loss in high nonlinearity backbone optical fiber 2:
0.7 dB/km×3 km=2.1 dB

Propagation loss in SMF backbone optical fiber 2:
0.4 dB/km×17 km=6.8 dB

Multiplexing/demultiplexing loss in star coupler:
18.5 dB

Propagation loss in branch optical fiber 41,42:
0.4 dB/km×4 km=1.6 dB

Transmission loss in WDMF: 1 dB

(Upstream Signal)

Optical power of LD for signal in ONU: 0 dBm

Transmission loss in WDMF: 1 dB

Propagation loss in branch optical fiber 41,42:
0.2 dB/km×4 km=0.8 dB

Multiplexing/demultiplexing loss in AWG: 6 dB

Propagation loss in SMF backbone optical fiber 2:
0.2 dB/km×17 km=3.4 dB

Raman gain in SMF backbone optical fiber 2:
0.84 dB→half, 0.4 dB

Propagation loss in high nonlinearity backbone optical fiber 2:
0.5 dB/km×3 km=1.5 dB

Raman gain in high nonlinearity backbone optical fiber 2:
6.8 dB→half, 4.6 dB

Multiplexing/demultiplexing loss in AWG: 6 dB

Transmission/reflection loss in WDMF: 1 dB

In the case specified as above, at a point at which upstream signal light from the ONU passes through the AWG by propagating through the branch optical fiber 4, signal power is −6.8 dBm.

When the Raman gain in the backbone optical fiber 2 is ignored, reception power of an upstream signal received at the PD in the base station is −19.7 dBm.

Because −23 dBm of down optical power is pumped into the backbone optical fiber 2, mathematically, the Raman gain in the high nonlinearity portion of the backbone optical fiber 2 is 6.8 dB, and the Raman gain in the SMF portion is 0.84 dB. However, the High LD in the OLT does not constantly emit light. Because a 1000BASE-LX light signal is encoded in such a manner that the number of 0-bits and the number of 1-bits are almost equal even in a silent state, the light-emitting time can be deemed as nearly half. Then, the Raman gain in the high nonlinearity portion of the optical fiber 2 is about half, 4.6 dB, and the Raman gain in the SMF portion is about half, 0.4 dB. Hence, the reception power at the PD of the OLT in the base station is −14.7 dBm as a result of the addition of (4.6+0.4) dB, which is the gain in the backbone fiber 2. This is a level that the OLT can receive with allowance.

The reception power at the ONU when light from the High LD in the OLT reaches the ONU is −7 dBm. This is power at a safe level when the subscriber has a physical contact.

Assume that the Manchester encoding is used to encode a downstream light signal, and a signal propagates at a communication rate of 10 Mbps through a 10-km-long optical fiber having an effective refractive index of 1.46. In this instance, information of about 500 bits is present in the optical fiber. Because the Manchester encoding is used for the encoding, it is possible to encode one bit or two bits using a set of a combination of an ON state and an OFF state in data to be encoded. This means that 250 to 500 sets of a combination of an ON state and an OFF state are present in the optical fiber. Because about a half of the bits are in the ON state and about the other half of the bits are in the OFF state, it is possible to obtain about half the gain through the Raman amplification for the entire optical fiber.

In the 1000BASE-LX, 8-bit information is converted to 10 bits by providing redundancy in the physical layer for communications. At least the ON state is present twice and the OFF state is present twice in this encoding with a few exceptions, and the codes are aligned in such a manner that the ON states and the OFF states are almost on halves. Hence, in the 1000BASE-LX, although it depends on the preceding or succeeding information, it is thought that at least two sets of a combination of an ON state and an OFF state are necessary to encode 8-bit information with a few exceptions. Given 1 M bits/sec as a transmission rate, then 8-bit information occupies about 1.6 m of the optical fiber, and one set of a combination of an ON state and an OFF state is thought to occupy about 0.8 m or less.

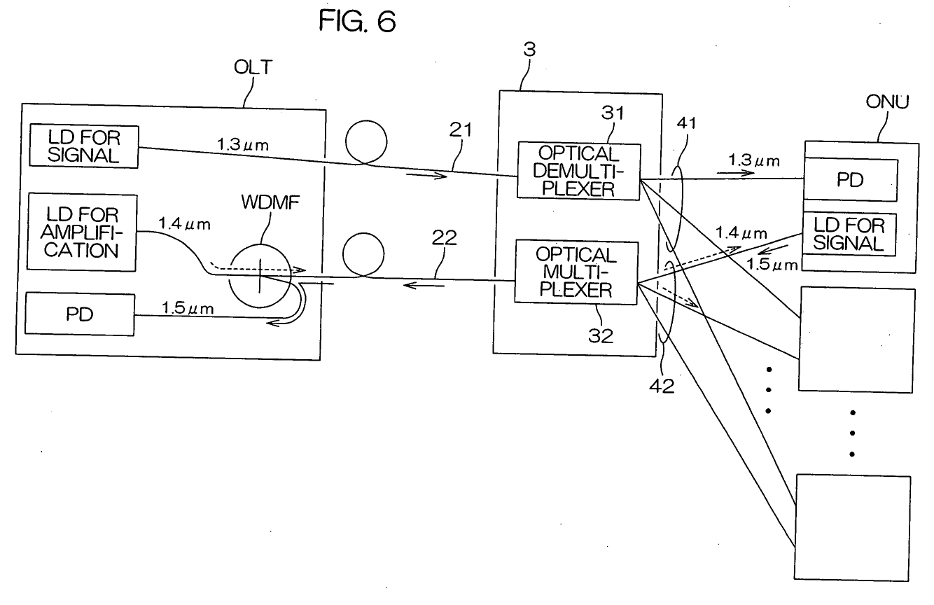

FIG. 6 is a network configuration view showing a state where the optical line terminal OLT in the base station 1, the optical branching station 3, and the optical network unit ONU in the local station 5 are interconnected. According to this configuration, an upstream signal from the optical branching station 3 to the base station 1 is amplified by providing a laser diode (LD) for amplification in the OLT.

The optical line terminal OLT in the base station 1 includes a laser diode for a downstream signal (LD for a signal, transmission wavelength: 1.3 μm), a laser diode for amplification of an upstream signal (LD for amplification, transmission wavelength: 1.4 μm), and a photo diode for an upstream signal (PD, reception wavelength: 1.5 μm). Both the LD for amplification and the PD are connected to a backbone optical fiber 22 by way of a WDMF (Wavelength Division Multiplexing Filter).

The optical network unit ONU in the local station 5 includes a laser diode for an upstream signal (LD for a signal, transmission wavelength: 1.5 μm) and a photo diode for a downstream signal (PD, reception wavelength: 1.3 μm).

The optical branching station 3 includes a star coupler 31, for optical demultiplexing, to couple a backbone optical fiber 21 to branch optical fibers 41, and a star coupler 32, for optical multiplexing, to couple branch optical fibers 42 to the backbone optical fiber 22.

Light from the LD for a signal in the base station 1 goes into the optical branching station 3 via the backbone optical fiber 21, and is demultiplexed into plural (for example, 32) wavelengths by means of the star coupler 31. The beams of demultiplexed light are connected to the respective branch optical fibers 41 and received at the PD's in the respective local stations 5.

Light from the LD for a signal in the local station 5 goes incident on the optical branching station 3 via the branch optical fiber 42, and is multiplexed by means of the star coupler 32. The multiplexed light goes into the optical line terminal OLT in the base station 1 via the backbone optical fiber 22. Light of this upstream signal is reflected on the WDMF in the OLT and received at the PD in the base station 1. Meanwhile, light having a wavelength of 1.4 μm irradiated from the LD for amplification in the base station 1 passes through the WDMF, and propagates through the backbone optical fiber 22. Further, it is demultiplexed by means of the star coupler 32 and the beams of demultiplexed light propagate through the branch optical fibers 42. Because the light having a wavelength of 1.4 μm has a wavelength about 0.1 μm shorter than light for an upstream signal having a wavelength of 1.5 μm, it is possible to amplify light for an upstream signal having a wavelength of 1.5 μm during propagation.

It should be noted that by forming, for example, a 3-km-long portion of the backbone optical fiber 22 on the station side using a high nonlinearity fiber and forming the remaining portion using an SMF, upstream signal light can be amplified more effectively.

When the Raman amplification is used, light for amplification with high power is necessary, and safety has to be concerned. In this configuration, however, because amplifying light is attenuated by the transmission path and the star coupler, power of light for amplification in the subscriber's home and the ONU, in and with which a physical contact by the general subscriber is highly likely, is attenuated satisfactorily. The safety concerns are therefore unnecessary, or simple concerns are sufficient.

An example of power design will be described with reference to the configuration of FIG. 6.

Optical power of LD for signal in OLT: 0 dBm

Optical power of LD for amplification in OLT: 25 dBm

Loss in backbone optical fiber 21: 0.3 dB/km×6 km

Raman gain in backbone optical fiber 21:
0.35 dB/km×6 km

Multiplexing/demultiplexing loss in star coupler 31:
18.5 dB

Loss in optical branch fiber 41:
0.2 dB/km×1 km

Optical power of LD for signal in ONU: −8 dBm

Transmission/reflection loss in WDMF: 0.5 dB

In the case specified as above, at a point at which upstream signal light from the ONU passes through the star coupler 31 by propagating through the branch optical fiber 41, signal power is −26.7 dBm.

In a case where the LD for amplification in the OLT is omitted, reception power at the PD in the OLT of an upstream signal having reached the base station is −29 dBm.

In a case where light is emitted from the LD for amplification in the OLT, reception power at the PD in the OLT in the base station is −26.9 dBm as a result of the addition of 2.1 dB, which is the gain in the backbone optical fiber 21.

In a case where light from the LD for amplification in the OLT is demultiplexed by means of the star coupler 31 and the beams of demultiplexed light reaches the ONU's, reception power in each local station is 4 dBm. This is a power at a safe level when the subscriber has a physical contact.

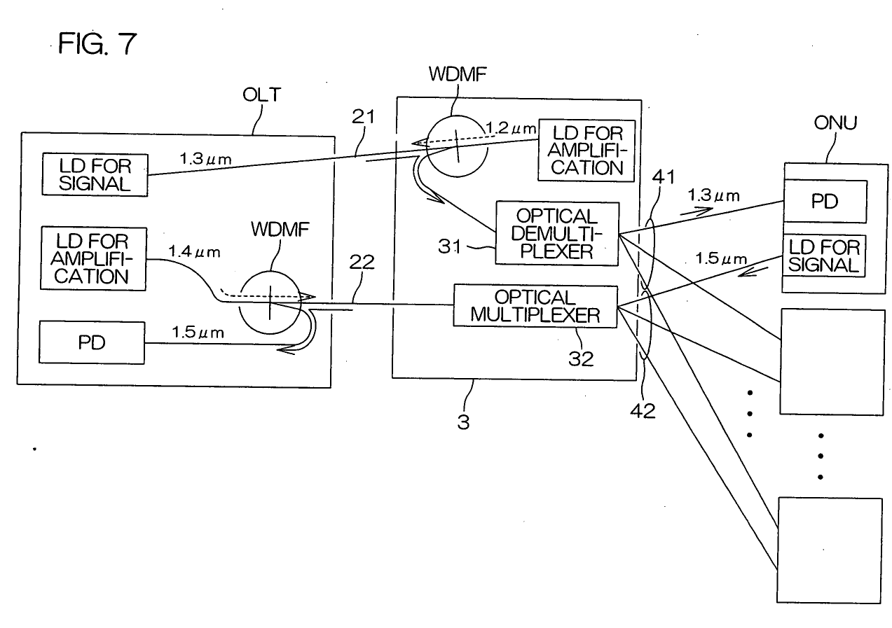

FIG. 7 is a network configuration view showing a state where the optical line terminal OLT in the base station 1, the optical branching station 3, and the optical network unit ONU in the local station 5 are interconnected. According to this configuration, in addition to the configuration of FIG. 6, a downstream signal from the base station 1 is amplified by providing an LD for amplification also in the optical branching station 3.

To describe only the additional configuration to FIG. 6, an LD for amplification (transmission wavelength: 1.2 μm) is provided in the optical branching station 3, and amplifying light from the LD for amplification is connected to a down backbone optical fiber 21 by way of the WDMF. Signal light from the OLT that propagates through the down backbone optical fiber 21 is reflected on the WDMF, and goes into the star coupler 31. Meanwhile, light for amplification irradiated from the LD for amplification in the base station 1 passes through the WDMF and propagates through the backbone optical fiber 21 between the base station 1 and the optical branching station 3. Because the light for amplification having a wavelength of 1.2 μm has a wavelength about 0.1 μm shorter than light for a downstream signal having a wavelength of 1.3 μm, it is possible to amplify light for a downstream signal during propagation.

In this embodiment, an LD for amplification is provided in the optical branching station; however, another station that serves as neither an OLT nor an optical branching station may be prepared, so that LD's for amplification are provided concentrically therein. In this case, for example, when ONU's are concentrated in a local area far from the OLT and distances among the optical branching stations in this area are short, the need to provide an LD for amplification in each optical branching station can be eliminated, which can in turn save the costs.

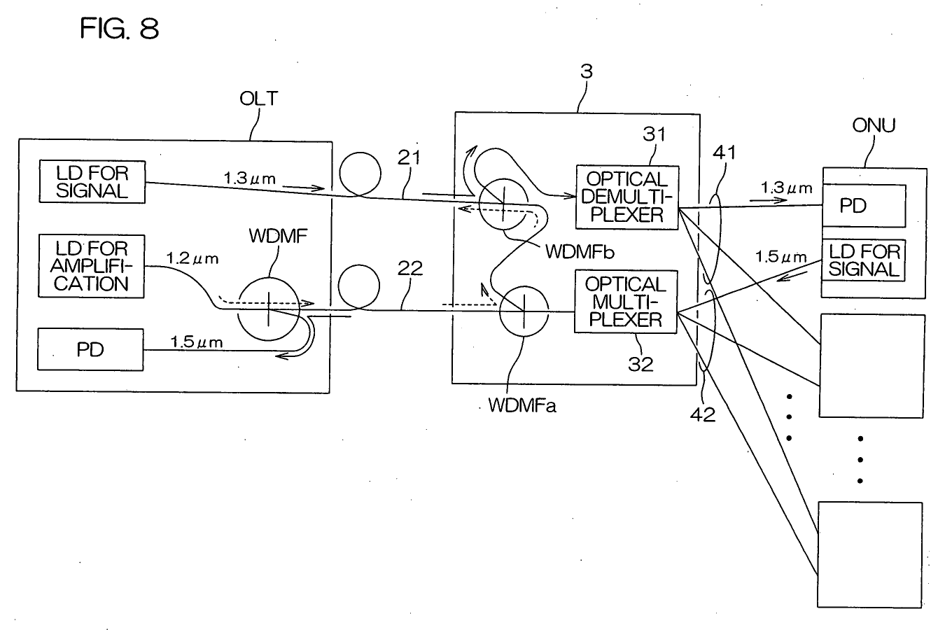

FIG. 8 is a network configuration view showing a state where the optical line terminal OLT in the base station 1, the optical branching station 3, and the optical network unit ONU in the local station 5 are interconnected. According to this configuration, both an upstream signal to the base station 1 and a downstream signal from the base station 1 can be amplified by merely providing a single LD for amplification in the optical line terminal OLT in the base station 1.

The configuration of the optical line terminal OLT in the base station 1 is completely identical with the configuration described with reference to FIG. 6 and FIG. 7. However, it is different in that a transmission wavelength of the LD for amplification is 1.2 μm.

Two WDMF's are provided in the optical branching station 3. One WDMFa reflects light from the LD for amplification in the OLT for the light to be inputted into the other WDMFb. The light inputted into the WDMFb reaches the OLT via a down backbone optical fiber 21. Because a wavelength of 1.2 μm of light for amplification is about 0.1 μm shorter than a wavelength of 1.3 μm for a downstream signal, light for a downstream signal can be amplified during propagation. Light having a wavelength of 1.3 μm from the LD for a signal in the base station 1 is also reflected on the WDMFb to go into the star coupler 31.

According to this configuration, by allowing light from the LD for amplification in the base station 1 to travel through both the up and down backbone fibers by way of the WDMFa and WDMFb in the optical branching station 3, it is possible to amplify a downstream signal from the base station 1. This enables the LD for amplification in the base station 1 to supply up amplifying light, which in turn enables downstream signal light to be amplified while omitting power supply from the optical branching station 3.

By setting the wavelengths of both upstream signal light and downstream signal light to 1.3 μm, it is possible to amplify both the upstream and downstream signals efficiently using a single LD for amplification.

In this embodiment, two WDMF's and two star couplers are prepared in the optical branching station. However, when AWG's are used instead of the star couplers, the same advantages can be achieved by connecting the WDMF to the AWG corresponding to a wavelength of the light for amplification.

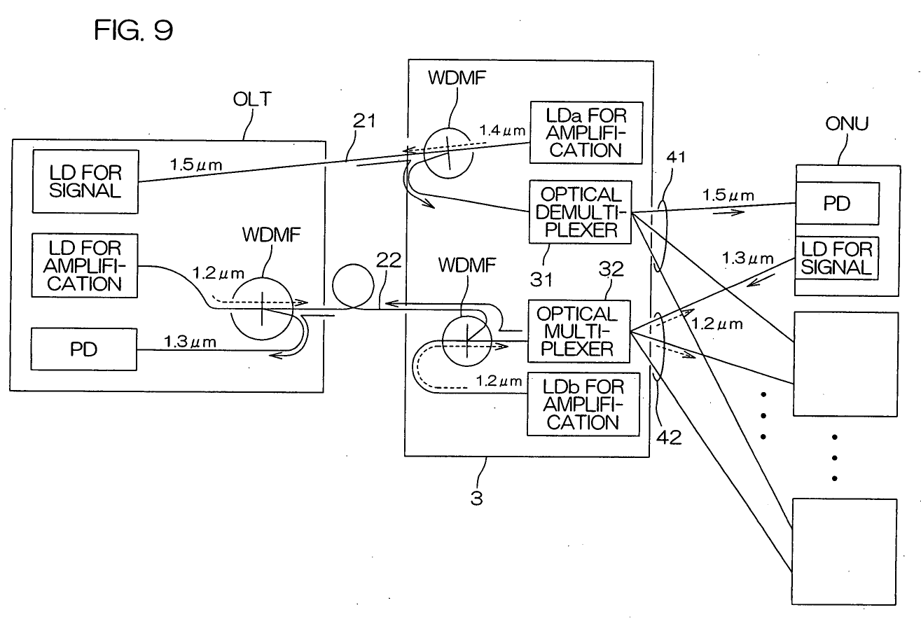

FIG. 9 shows the configuration of a PON system including an additional configuration to the configuration of FIG. 7, in which an upstream light signal from the optical network unit ONU in the local station 5 to the optical line terminal OLT in the base station 1 is amplified with light from an LDb for amplification provided in the optical branching station 3.

To describe only the additional configuration to FIG. 7 alone, an LDb for amplification (transmission wavelength: 1.2 Mm) is provided in the optical branching station 3, and amplifying light from the LDb for amplification goes into the star coupler 32 by way of the WDMF. The light is then demultiplexed and the beams of demultiplexed light travel through the branch optical fibers 42 down to the respective local stations 5. An upstream signal (transmission wavelength: 1.3 μm) from the LD for a signal in the ONU is amplified with the amplifying light in the branch optical fiber 42 before it reaches the optical branching station 3.

In this embodiment, the WDMF's and the 1:N star couplers are used; however, the same advantages can be achieved using 2:N star couplers alone. In this case, although optical power is reduced to half, both the cost and the size can be reduced because the WDMF's can be omitted.

In an example as follows, a single mode optical fiber that enables two-way propagation of a light signal is used.

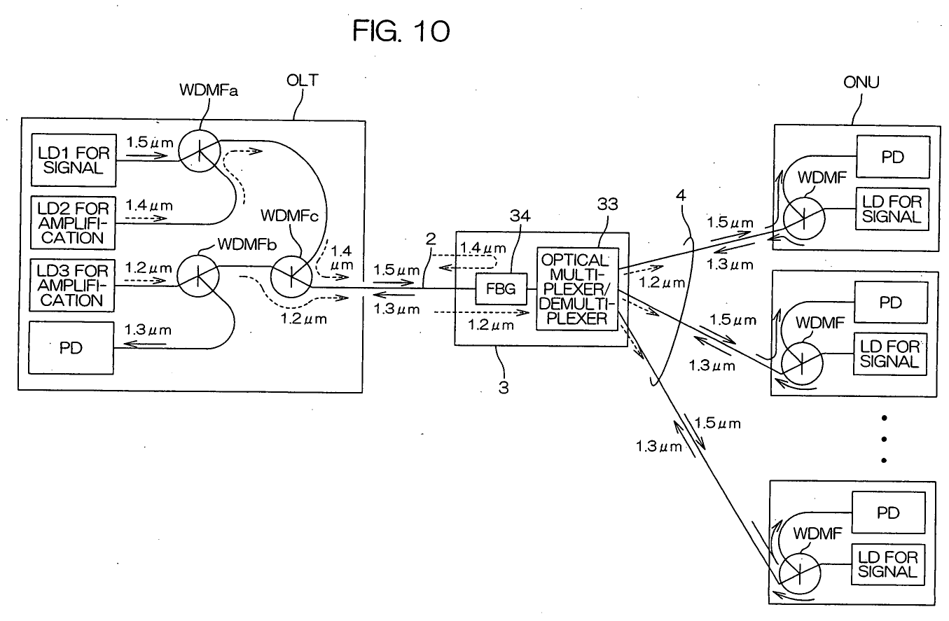

FIG. 10 is a network configuration view showing a state where the optical line terminal OLT in the base station 1 and the optical network unit ONU in the local station 5 are connected to each other. According to this configuration, by providing LD 2 and LD 3 for amplification in the OLT, a downstream signal propagating through the backbone optical fiber 2 between the base station 1 and the optical branching station 3 is amplified with light from the LD 2, and an upstream signal propagating through the backbone optical fiber 2 between the base station 1 and the optical branching station 3 as well as the branch optical fiber 4 between the optical branching station 3 and the local station 5 is amplified with light from the LD 3.

The optical line terminal OLT in the base station 1 includes a laser diode for a downstream signal (LD 1 for a signal, transmission wavelength: 1.5 μm), a laser diode for amplification of a downstream signal (LD 2 for amplification, transmission wavelength: 1.4 μm), a laser diode for amplification of an upstream signal (LD 3 for amplification, transmission wavelength: 1.2 μ), a photo diode (PD, reception wavelength: 1.3 μm), and WDMFa through WDMFc. Light from the LD 2 for amplification is reflected on the first WDMFa, and is then reflected on the third WDMFc, so that it propagates through the backbone optical fiber 2 down to the optical branching station 3. Light from the LD 3 for amplification passes through the second WDMFb and the third WDMFc, and propagates through the backbone optical fiber 2 down to the optical branching station 3.

A fiber Bragg grating FBG 34 of a band elimination type is inserted in the optical branching station 3. This fiber Bragg grating reflects light having a wavelength of 1.4 μm and transmits light having any other wavelength. Hence, light having a wavelength of 1.4 μm from the LD 2 for amplification is reflected and returns to the base station 1. Light having a wavelength of 1.5 μm from the LD 1 for a signal is thus amplified with light having a wavelength of 1.4 μm from the LD 2 for amplification that returns while the light is propagating through the backbone optical fiber 2. This enables the LD 2 for amplification in the base station 1 to supply up amplifying light, which in turn enables downstream signal light to be amplified while omitting the power supply from the optical branching station 3.

Light having a wavelength of 1.2 μm from the LD 3 for amplification passes through the FBG 34, and is then demultiplexed by means of the star coupler 33 functioning as an optical multiplexer/demultiplexer. The beams of demultiplexed light travel through the branch optical fibers 4 down to the respective local stations 5.

The optical network unit ONU in the local station 5 includes a laser diode for an upstream signal (LD for a signal, transmission wavelength: 1.3 μm), a photo diode for a downstream signal (PD, reception wavelength: 1.5 μm), and a WDMF. A downstream signal propagating through the branch optical fiber 4 is reflected on the WDMF and transmitted to the PD. Light from the LD for a signal passes through the WDMF and propagates through the branch optical fiber 4 in an upward direction.

Because the wavelength of upstream signal light from the LD for a signal is 1.3 μm, and the wavelength of light for down amplification from the LD 3 for amplification is 1.2 μm, the upstream signal light from the LD for a signal is amplified while propagating through the branch optical fiber 4 between the optical branching station 3 and the local station 5, and is also amplified while propagating through the backbone optical fiber 2 between the base station 1 and the optical branching station 3.

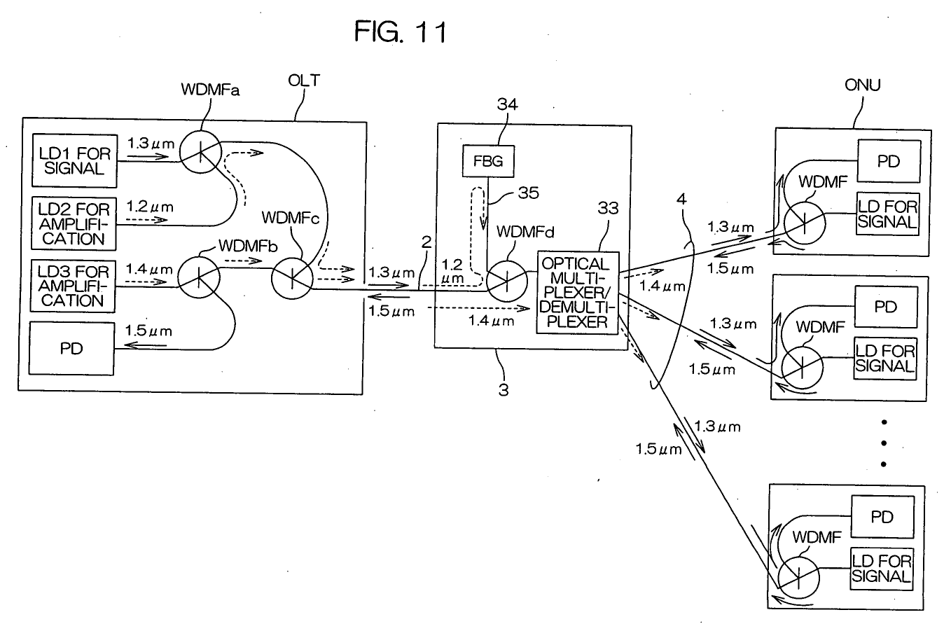

FIG. 11 is a network configuration view showing a state where the optical line terminal OLT in the base station 1 and the optical network unit ONU in the local station 5 are connected to each other. According to this configuration, by providing LD 2 and LD 3 for amplification in the base station 1, a downstream signal propagating through the backbone optical fiber 2 between the base station 1 and the optical branching station 3 is amplified with light from the LD 2, while an upstream signal propagating through the backbone optical fiber 2 between the base station 1 and the optical branching station 3 as well as the branch optical fiber 4 between the branching station 3 and the local station 5 is amplified with light from the LD 3.

Differences from FIG. 10 are that the transmission wavelength of the laser diode LD 1 for a downstream signal is 1.3 μm, the reception wavelength of the photo diode PD is 1.5 μm, the transmission wavelength of the LD 2 for amplification is 1.2 μm, and the transmission wavelength of the LD 3 for amplification is 1.4 μm, and that the WDMFd, a fiber Bragg grating FBG 34 of a band reflection type, and an optical fiber 35 that connects these elements are provided in the optical branching station 3. The WDMFd reflects light having a wavelength of 1.2 μm and transmits light having any other wavelength. The fiber Bragg grating FBG34 allows light having a wavelength of 1.2 μm that was reflected on the WDMFd to undergo total reflection.

Hence, light having a wavelength of 1.2 μm from the LD 2 for amplification returns to the WDMFd, and returns to the base station 1 by propagating through the backbone optical fiber 2. Light having a wavelength of 1.3 μm from the LD 1 for a signal is thus amplified with light having a wavelength of 1.2 μm from the LD 2 for amplification that has returned while the light is propagating through the backbone optical fiber 2. This enables the LD 2 for amplification in the base station 1 to supply up amplifying light, which in turn enables downstream signal light to be amplified while omitting the power supply from the optical branching station 3.

Light having a wavelength of 1.4 μm from the LD 3 for amplification is allowed to pass through and demultiplexed by means of the star coupler 33 functioning as an optical multiplexer/demultiplexer. The beams of demultiplexed light travel through the branch optical fibers 4 down to the respective local stations 5.

Only the difference of the local station 5 from FIG. 10 is that the wavelengths are exchanged in such a manner that the transmission wavelength of the LD for an upstream signal is 1.5 μm and the reception wavelength of the PD for a downstream signal is 1.3 μm.

Upstream signal light having a wavelength of 1.5 μm from the LD for a signal is amplified with light having a wavelength of 1.4 μm from the LD 3 for amplification while the upstream signal light is propagating through the branch optical fiber 4 between the optical branching station 3 and the local station 5, and it is also amplified with light having a wavelength of 1.4 gm from the LD 3 for amplification while it is propagating through the backbone optical fiber 2 between the base station 1 and the optical branching station 3.

The FBG 34 may be replaced with reflection processing, such as metal film coating, applied onto the end face of the optical fiber 35 through which reflected light from the WDMFd propagates. This allows light having a wavelength of 1.2 μm that has been reflected on the WDMFd to undergo total reflection.

Also, in this embodiment, light for amplification is extracted in the WDMF preceding the star coupler. However, when an AWG is used as the optical multiplexer/demultiplexer 33, the same advantages can be achieved by providing a device (FBG, an optical fiber whose end face is processed for total reflection to take place) that allows total reflection to a port from which the light for amplification is extracted.

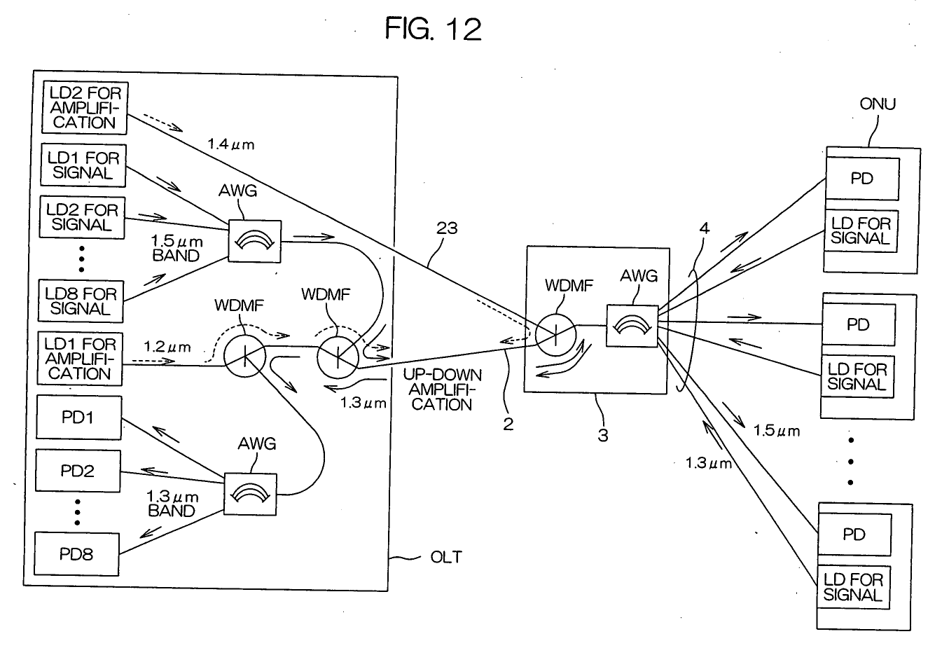

FIG. 12 is a network configuration view showing a state where the optical line terminal OLT in the base station 1 and the optical network unit ONU in the local station 5 are connected to each other. According to this configuration, upstream and downstream signals propagating through the backbone optical fiber 2 between the base station 1 and the optical branching station 3 are amplified by providing LD 1 and LD 2 for amplification in the base station 1.

The optical line terminal OLT in the base station 1 includes eight laser diodes for a signal (LD 1 through LD 8 for a signal, transmission wavelength: 1.5 μm band), a laser diode for amplification of a downstream signal (LD 2 for amplification, transmission wavelength: 1.4 μm), a laser diode for amplification of an upstream signal (LD 1 for amplification, transmission wavelength: 1.2 μm), eight photo diodes (PD 1 through PD 8, reception wavelength: 1.3 μm band), two AWG's (Arrayed-Wavelength Gratings), and two WDMF's.

Eight transmission signals are subjected to wavelength division multiplexing (WDM) in the AWG and propagate through the backbone optical fiber. Reception signals are demultiplexed in the AWG according to the wavelengths and received at the respective PD's.

An optical fiber 23 is independently provided between the base station 1 and the optical branching station 3.

The WDMF and the AWG are provided in the optical branching station 3. The WDMF reflects light having a wavelength of 1.4 μm from the LD 2 for amplification and transmits any other light. An AWG wave, a downstream signal propagating through the backbone optical fiber 2 are demultiplexed according to the wavelengths and sent to the respective ONU's via the branch optical fibers 4.

Operations according to this configuration will now be described. Light having a wavelength of 1.4 μm from the LD 2 for amplification reaches the optical branching station 3 via the independently provided optical fiber 23. It is then reflected on the WDMF in the optical branching station 3 and returns to the base station 1 by propagating through the backbone optical fiber 2 in the upward direction.

Light having a wavelength of 1.2 μm from the LD 1 for amplification passes through the two WDMF's and propagates through the backbone optical fiber 2 in the downward direction.

Meanwhile, a light signal having a wavelength of 1.5 μm band emitted from any of the LD 1 through LD 8 for a signal (for example, LD 1 for a signal) in the base station 1 passes through the AWG and is reflected on the WDMF to exit from the backbone optical fiber 2. During this propagation, it is amplified with return light having a wavelength of 1.4 μm from the LD 2 for amplification. This enables the LD 2 for amplification in the base station 1 to supply up amplifying light, which in turn enables downstream signal light to be amplified while omitting the power supply from the optical branching station 3.

Light having a wavelength of 1.3 μm that exits from the local station 5 and reaches the optical branching station 3 passes through the AWG and the WDMF in the optical branching station 3, and reaches the base station 1 by propagating through the backbone optical fiber 2. It is amplified with light having a wavelength of 1.2 μm from the LD 1 for amplification while it is propagating through the backbone optical fiber 2.

As has been described, both the upstream and downstream light signals can be amplified with light from the LD 1 and LD 2 for amplification.

It is more effective to use a high nonlinearity fiber for the backbone optical fiber 2 and an SMF for the other optical fiber 23.

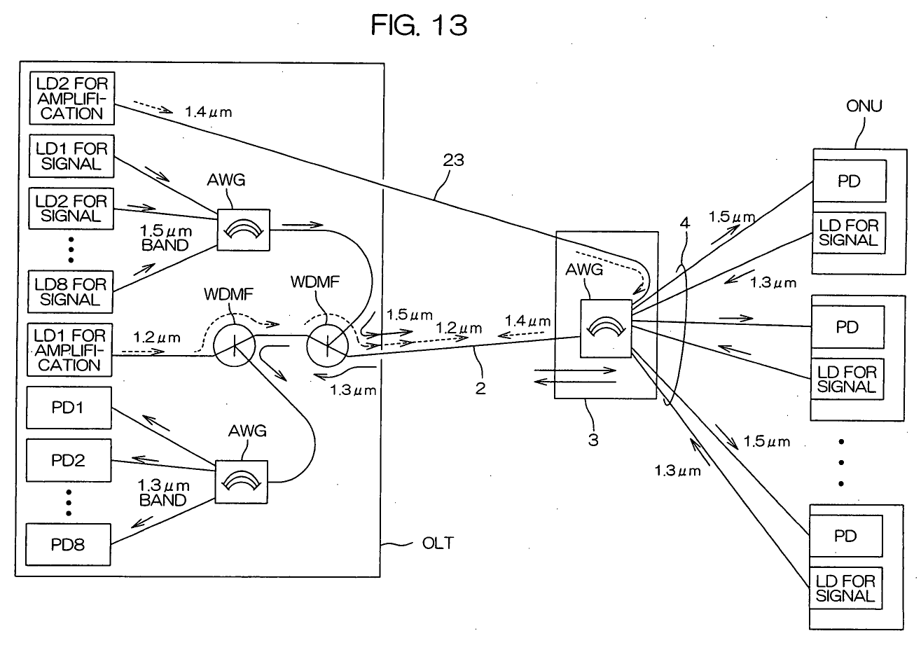

FIG. 13 is a network configuration view showing a state where the optical line terminal OLT in the base station i and the optical network unit ONU in the local station 5 are connected to each other. According to this configuration, as with FIG. 12, upstream and downstream signals propagating through the backbone optical fiber 2 between the base station 1 and the optical branching station 3 are amplified by providing LD 1 and LD 2 for amplification in the base station 1.

A difference from FIG. 12 is that instead of providing the WDMF in the optical branching station 3, light from the LD 2 for amplification that has propagated through the independently provided optical fiber 23 is allowed to go into the AWG from a branch of the AWG on the local station 5 side in the same manner as light from the local station 5.

This enables light for amplification having a wavelength of 1.4 μm to propagate through the backbone optical fiber 2 between the optical branching station 3 and the base station 1 toward the base station 1. It is thus possible to amplify light for a downstream signal having a wavelength of 1.5 μm exiting from the base station 1. This enables the LD 2 for amplification in the base station 1 to supply up amplifying light, which in turn enables downstream signal light to be amplified while omitting the power supply from the optical branching station 3.

While the embodiments of the invention have been described, the implementation of the invention is not limited to the embodiments above. For example, the ONU in the local station includes the LD for an upstream signal and the PD for a downstream signal in the embodiments above. However, the LD for an upstream signal may be omitted, so that light coming incident as a downstream signal is demultiplexed by means of a 3 dB coupler, and modulation processing to change a wavelength (see Japanese Unexamined Patent Publication No.2001-177505 A) is performed, so that the light can be used as upstream signal light. Alternatively, an optical filter may be provided in the preceding stage of the photo diode PD. In addition, various modifications within the scope of the invention are possible.

1. An optical communications system in which a base station and a local station are connected using an optical fiber, the optical communications system being characterized in that
a wavelength of a light source for a signal that generates downstream signal light is set to a wavelength with an effect of Raman amplifying an upstream light signal that propagates through the optical fiber, and an upstream light signal transmitted between the base station and the local station is amplified in the optical fiber while the upstream light signal is propagating through the optical fiber.

2. The optical communications system according to claim 1, wherein
a high nonlinearity fiber is used for at least part of the optical fiber.

3. The optical communications system according to claim 1 or 2, wherein
light that is switched ON and OFF is used as the downstream signal light, and a modulation method, by which an ON state and an OFF state transit even when coded data is a sequence of 0's and the ON state and the OFF state transit even when the coded data is a sequence of 1's, is used as a modulation method for the downstream signal light.

4. The optical communication system according to claim 3, wherein
in the backbone optical fiber, a length of a portion where upstream signal light is amplified is of a distance longer than a length of the optical fiber corresponding to a set of the ON state and the OFF state of the downstream signal light.

5. The optical communication system according to any of claims 1 through 4, wherein
the base station is provided with an optical filter used to select a wavelength of light coming incident on a light-receiving element.

6. A PON (Passive Optical Network) system in which a base station and an optical branching station equipped with a passive optical divider are connected using a backbone optical fiber, and the optical branching station and plural local stations are connected individually using branch optical fibers, the PON system being characterized in that
a wavelength of a light source for a signal that generates downstream signal light is set to a wavelength with an effect of Raman amplifying an upstream light signal that propagates through the backbone optical fiber, and an upstream light signal transmitted between the base station and each local station is amplified in the backbone optical fiber while the upstream light signal is propagating through the backbone optical fiber.

7. The PON system according to claim 6, wherein
a high nonlinearity fiber is used for at least part of the backbone optical fiber.

8. The PON system according to claim 6 or 7, wherein
light that is switched ON and OFF is used as the downstream signal light, and a modulation method, by which an ON state and an OFF state transit even when coded data is a sequence of 0's and the ON state and the OFF state transit even when coded data is a sequence of 1's, is used as a modulation method for the downstream signal light.

9. The PON system according to claim 8, wherein
in the backbone optical fiber, a length of a portion where upstream signal light is amplified is of a distance longer than a length of the backbone optical fiber corresponding to a set of the ON state and the OFF state of the downstream signal light.

10. The PON system according to any of claims 6 through 9, wherein
the light source for a signal and an optical multiplexer/demultiplexer are provided in the base station, and light for a signal is pumped into the backbone optical fiber from the base station toward the optical branching station by way of the optical multiplexer/demultiplexer.

11. The PON system according to any of claims 6 through 10, wherein
a star coupler is used as the passive optical divider.

12. The PON system according to any of claims 6 through 10, wherein
as the passive optical divider, a star coupler is used for the downstream signal light, and an AWG (Arrayed-Waveguide Grating) capable of multiplexing and demultiplexing upstream signal light using a difference in wavelength is used for the upstream signal light.

13. A PON (Passive Optical Network) system in which a base station and an optical branching station equipped with a passive optical divider are connected using a backbone optical fiber, and the optical branching station and plural local stations are connected individually using branch optical fibers, the PON system being characterized by comprising:
a light source for amplification that generates light for amplification having a wavelength with an effect of amplifying a light signal propagating through an optical fiber (including a backbone optical fiber and a branch optical fiber, and the same applies hereinafter); and
an optical multiplexer/demultiplexer used to pump the light for amplification into the optical fiber,
wherein, in the optical fiber, a light signal transmitted between the base station and each local station is amplified while the light signal is propagating through the optical fiber.

14. The PON system according to claim 13, wherein
Raman amplification is used as a function of amplifying a light signal, and the light for amplification propagates in a direction opposite to the signal light.

15. The PON system according to claim 13 or 14, wherein
a high nonlinearity fiber is used.

16. The PON system according to claim 13, wherein
an erbium-doped fiber (EDF) is used as a function of amplifying the light signal, and the signal for amplification is in the same direction as the signal light.

17. The PON system according to claim 13, wherein
the light source for amplification and the optical multiplexer/demultiplexer are provided in the base station, and the light for amplification is pumped into the backbone optical fiber from the base station toward the optical branching station.

18. The PON system according to claim 13, wherein
the light source for amplification and the optical multiplexer/demultiplexer are provided in the optical branching station, and the light for amplification is pumped into the backbone optical fiber from the optical multiplexer/demultiplexer toward the base station.

19. The PON system according to claim 17, wherein
a second optical multiplexer/demultiplexer, a third optical multiplexer/demultiplexer, and an optical path connecting the second optical multiplexer/demultiplexer and the third optical multiplexer/demultiplexer are provided in the optical branching station,
the light for amplification that travels through a backbone optical fiber for an upstream signal is extracted from the second optical multiplexer/demultiplexer to be supplied to the third optical multiplexer/demultiplexer via the optical path, and
the light for amplification is pumped into a backbone optical fiber for a downstream signal from the third optical multiplexer/demultiplexer toward the base station.

20. The PON system according to claim 13, wherein
the light source for amplification and the optical multiplexer/demultiplexer are provided in the optical branching station, and the light for amplification is pumped into the branch optical fiber by way of the passive optical divider toward the local station.

21. The PON system according to claim 13, wherein
the light source for amplification and the optical multiplexer/demultiplexer are provided in the base station, and the light for amplification is pumped into the backbone optical fiber from the base station toward the optical branching station, and
a reflector that allows the light for amplification to undergo total reflection to the backbone optical fiber is provided in the optical branching station.

22. The PON system according to claim 13, wherein
the light source for amplification and the optical multiplexer/demultiplexer are provided in the base station, and the light for amplification is pumped into the backbone optical fiber from the base station toward the optical branching station,
a second optical multiplexer/demultiplexer and a reflector are provided in the optical branching station, and
the light for amplification that travels through the backbone optical fiber is extracted from the second optical multiplexer/demultiplexer, so that the light for amplification is allowed to undergo total reflection on the reflector.

23. The PON system according to claim 13, wherein
the optical multiplexer/demultiplexer is provided in the optical branching station;
an optical fiber is provided between the base station and the optical branching station besides the backbone optical fiber, and
the light source for amplification is provided in the base station, and the light for amplification is supplied to the optical multiplexer/demultiplexer via the optical fiber, so that the light for amplification is pumped into the backbone optical fiber from the optical multiplexer/demultiplexer toward the base station.

24. The PON system according to any of claims 17 through 23, wherein
a star coupler is used as the passive optical divider.

25. The PON system according to claim 13, wherein
an optical fiber is provided between the base station and the optical branching station besides the backbone optical fiber, and
the light source for amplification is provided in the base station, so that the light for amplification is pumped into one optical path of the optical multiplexer/demultiplexer on the local station side via the optical fiber toward the base station.

26. The PON system according to any of claims 17 through 23 and 25, wherein
an AWG (Arrayed-Waveguide Grating) capable of multiplexing and demultiplexing light using different wavelengths is used as the passive optical divider.
